(19) United States
(12) Patent Application Publication
(10) Pub. No.: US 2024/0368787 A1
(43) Pub. Date: Nov. 7, 2024

(54) WATER ELECTROLYSIS STACK FOR GENERATING HYDROGEN AND OXYGEN FROM WATER

(71) Applicant: Hoeller Electrolyzer GmbH, Wismar (DE)

(72) Inventor: Stefan HÖLLER, Lübeck (DE)

(21) Appl. No.: 18/558,387

(22) PCT Filed: May 3, 2021
(86) PCT No.: PCT/EP2021/061583

§ 371 Date: Nov. 1, 2023

(51) Int. Cl. C25B 15/08; C25B 1/04; C25B 9/23; C25B 9/70; C25B 11/032; C25B 11/036; C25B 13/08

(52) U.S. Cl. CPC C25B 15/083; C25B 1/04; C25B 9/23; C25B 9/70; C25B 11/032; C25B 11/036; C25B 13/08

(57) ABSTRACT

A water electrolysis stack for producing hydrogen and oxygen from water has a number of PEM electrolysis cells, arranged to form a cell stack. The cell stack is penetrated by a first channel for supplying water, a second channel for removing water and the product gas oxygen and a third channel for removing gas hydrogen. The electrolysis cells have a catalytically coated proton exchange membrane, adjoining a bipolar plate via a sealing frame on the hydrogen side, the rear side of which bipolar plate bears on the oxygen side against the membrane of the adjacent cell. The bipolar plate is a sintered component and has a flat metallic plate, which accommodates a channel-forming element at a central recess and a second metallic frame with a central recess and porous transport layer, which is integrated therein. The channels connect the first and second channel of the cell stack.

### CROSS REFERENCE TO RELATED APPLICATIONS

This application is a United States National Phase Application of International Application PCT/EP2021/061583, filed May 3, 2021, the entire contents of which are incorporated herein by reference.

### TECHNICAL FIELD

The present invention relates to a water electrolysis stack for producing hydrogen and oxygen from water, which consists of a multiplicity of electrolysis cells of PEM design, which are arranged to form a cell stack.

### BACKGROUND

Electrolysis stacks of this type belong to the prior art and are increasingly used for producing “green hydrogen” from renewable electricity. Stacks of this type are for the most part mechanically clamped between two end plates and close to the stack sides have channels which penetrate these stack sides, which channels supply the PEM electrolysis cells with the reactant water and also cooling water and are used for removing the product gas oxygen and the cooling water on one side and the product gas hydrogen on the other side. Whilst the hydrogen removal inside the cell stack is relatively unproblematic, the water supply, with which water is to be supplied as reactant of the electrolysis cell in a satisfactory quantity on the one hand and with which water is to be supplied and removed as cooling water on the other hand, is more technically demanding.

It belongs to the prior art to provide porous transport layers in the electrolysis cells, which consist of titanium expanding metals, titanium felt or sintered titanium powder. Transport channels are required in order to be able to supply or remove process media to or from these transport layers, which transport channels are to be provided at the rear side of the transport layers in order to ensure a satisfactory supply of the cells in the case of high power density. In addition, it belongs to the prior art to use bipolar plates with stamped channels, through which the water carried in the side channels, which penetrate the stack, can be brought up to the PEM in sufficient quantity and removed from the same again. Alternatively, these channels are formed by inserting expanded metals between the transport layer and a flat bipolar plate. Both variants have disadvantages. If channels are stamped into the bipolar plate, then these channels are open towards the transport layer and must be bridged by the same. In the case of electrolysers which are operated with low operating pressures, this is for the most part unproblematic, with increasing operating pressure by contrast, a supporting component, e.g. a perforated plate, must be inserted, so that the porous transport layer does not push into the channels. Supporting components of this type increase the overall size and the costs.

To this extent, the variant in which the expanded metals are inserted between the transport layer and the flat bipolar plate is more beneficial. Owing to the construction of the expanded metals, however, metal sections are created, which lie transversely inside the throughflow direction and form an additional barrier during the throughflow. This is particularly problematic if the expanded metals are strongly compressed inside the stack. Then, a multilayered shoring is often necessary, which increases the thickness of the individual electrolysis cell and therefore of the cell stack and furthermore leads to increased production costs.

### SUMMARY

Against this background, the invention is based on the object of simplifying and improving a water electrolysis stack of the previously mentioned type with regards to its structure, particularly to avoid the previously mentioned problems.

This object is achieved by a water electrolysis stack with features according to this disclosure. Advantageous embodiments of the invention are specified in the following description and the drawing.

The water electrolysis stack according to the invention for producing hydrogen and oxygen from water has a number of electrolysis cells of Polymer Electrolyte Membrane design, which are arranged to form a cell stack. At least one first channel, which penetrates the cell stack, is provided for supplying water to the electrolysis cells and at least one second channel, which penetrates the cell stack, is provided for removing the surplus water/the cooling water and for removing the oxygen. Furthermore, at least one third channel, which penetrates the cell stack, is provided for removing the hydrogen. The electrolysis cells have bipolar plates which are formed from at least one sintered component. This sintered component is built using a flat metallic plate, on which a first metallic frame is arranged, which has a channel-forming element in its central recess, which element is integrated into this metallic frame. A second metallic frame is arranged on the first metallic frame, which second metallic frame has a porous transport layer integrated into its central recess. The channel-forming element is arranged such in this case that, of the channels which penetrate the cell stack, it line-connects the first to the second channel.

The fundamental structure of the water electrolysis stack typically has a first channel, which penetrates the cell stack, for supplying water, and also a second channel, which is usually arranged opposite and likewise penetrates the cell stack and which is provided for removing the surplus water/cooling water and via which the oxygen formed during the electrochemical reaction is removed. The third channel, which penetrates the cell stack, may likewise be formed in pairs by two opposite channels arranged close to the remaining sides of the water electrolysis stack, but also by a single channel or adjacent channels. This channel is used for removing the hydrogen formed during the electrochemical reaction.

The bipolar plates of the water electrolysis stack according to the invention are formed from at least one sintered component, advantageously the bipolar plates are formed from only one sintered component, which preferably consists of titanium or a titanium alloy. In this case, the structure of the bipolar plates is exceptionally material-saving and effective, even the overall height is comparatively small.

The channel-forming element, which is arranged in a metallic frame between a flat metallic plate and a further frame with integrated porous transport layer, is provided for the supply and removal of the oxygen side of the electrolysis cell. A highly effective reactant/cooling water supply to the membrane and cooling water removal and oxygen removal from the membrane are ensured by means of the channel-forming element, which has a multiplicity of channels which connect the first and the second channel to one another in the stack. As the channel-forming elements of the bipolar plates are integrated into frames, they only have to accommodate comparatively low pressures, even in the case of operation of the water electrolysis stack with a high operating pressure of 80 bar for example. In particular, they are not subject to the directive on pressure equipment as pressure-bearing components, as it is the case for a wave-like shaping of the bipolar plate as a whole. For this reason, small material thicknesses can be used for the channel-forming elements. Large clear throughflow cross sections are created, which are advantageous for the throughflow of the stack with water in particular. Although an appropriate hydrogen removal is also to be arranged on the hydrogen side, this is substantially easier to configure, because of the pressure forming there and the gaseous hydrogen, which only requires small flow cross sections.

The sintered component according to the invention is constructed with a flat metallic plate, a first metallic frame, which is arranged on the flat metallic plate, having a channel-forming element which is integrated in the first metallic frame, and with a second metallic frame, which is arranged on the first metallic frame, having a porous transport layer which is integrated in the second metallic frame. This design is not to be understood as definitive, but rather represents the components which are at least present according to the invention for this sintered component. The individual components are typically all formed from titanium and they are either produced in a solid manner or for example in MIM injection molding as green parts or brown parts and assembled and then sintered e.g. between ceramic plates, in order to form a one-piece sintered component and therefore a bipolar plate.

The channel-forming element provided on the oxygen side of the bipolar plate can according to the invention either be formed by a profiled sheet, typically a corrugated sheet, or else by a porous transport layer, which is penetrated by channels. As the profiled sheet essentially has a flow-conducting function, large flow cross sections can be realized in the channels. The cross section does not have to run sinusoidally, but rather square waves or rounded square waves may preferably be formed, which are advantageous with regards to the throughflow capacity. Advantageously, the corrugated sheet of this channel-forming element on the oxygen side is constructed such that the wave spacing is smaller than 2 mm, preferably smaller than 1.5 mm and in a particularly preferred design smaller than 1.0 mm. Thus, comparatively narrow tall channels can be realized, which is advantageous.

If the channel-forming element is formed as a porous transport layer, then this may either be configured such that the channels are completely integrated into the transport layer or else such that the channels are formed to be open at least to one side. In the latter case it is advantageous to configure the channels such that they are closed by the flat metallic plate. In this manner, a large channel cross section can be achieved for a comparatively thin transport layer. The channels may be formed by inserting corresponding rods during injection molding of the green part, which rods are thermally or chemically dissolved, or by stamping into the surface of the transport layer.

In this case, it is advantageous according to the invention to arrange the channels of the channel-forming element to be as straight as possible and parallel with one another, in order to achieve a smallest possible throughflow resistance. However, it may be advantageous to arrange the channels with a wavy line shape and advantageously offset parallel with one another in such a manner that although a barrier-free passage is maintained, the static support function of the component is increased. The channels are then shaped such that they have a preferably straight clear passage, but the side wall is configured in a wave-like manner, in order to achieve this support function.

In the sense of the invention, barrier-free is to be understood to mean that no impact bodies which induce turbulence in the flow are present in the channels, as it is typically the case for obstacles which are arranged at an angle transversely or obliquely to the direction of flow. A channel running in a wave-like manner can therefore be barrier-free if it runs through the body e.g. in a sinusoidal or wave-like manner in space.

Fundamentally, the channel-forming element can be arranged and formed in the first metallic frame such that the ends of the element open out into the first or the second channel-which penetrates the cell stack-for supplying water or for removing water and removing oxygen. When operating the stack at high pressures, it may be advantageous however, for support, not to form this channel-forming element between the perpendicular channels continuously, but rather to provide corresponding channels in the metallic frame on both sides, e.g. by stamping, which preferably lie flush with the channels of the channel-forming element and line-connect the same to the first or the second channel, which penetrates the stack. One such design has a higher stability or makes it possible to lay out the channel-forming element for a smaller supported load.

In order to enable the hydrogen removal from the hydrogen-carrying side of the electrolysis cell through the bipolar plate, it is advantageous according to a development of the invention to provide the flat metallic plate with recesses or apertures, which open out into channels which are formed in the first metallic frame, e.g. by stamping and which open out into the third channel, which penetrates the cell stack, for removing hydrogen. These channels may be open on one side and, following sintering, covered by the second metallic frame, which is arranged thereon, and closed by the same. The recesses in the flat metallic plate are advantageously configured as rows of adjacent apertures which ensure a satisfactory passage of the product gas hydrogen.

In order to ensure a suitable removal to the recesses in the flat metallic plate of the sintered component on the hydrogen side of the electrolysis cell, it is advantageous to provide a frame on the side of the bipolar plate formed by the flat metallic plate, which frame bears against this side in a sealing manner and has a central recess, in which a further channel-forming element is arranged, the channels of which are line-connected to the recesses in the flat metallic plate. At the same time, this frame advantageously forms the sealing element between bipolar plate and PEM, it has peripheral seals, on one side facing the bipolar plate and on the other side facing the PEM. The seals are arranged such that they run around the recesses, which form the channels which penetrate the stack, and also run around the central recess, which forms the active part of the electrolysis cell.

This further channel-forming element, which is arranged on the hydrogen side of the electrolysis cell, can advantageously be formed as a gas diffusion layer which is built from ordered or disordered carbon fibers. Preferably, carbon fibers are arranged here, which are connected to form a felt-like knitted fabric.

Alternatively, this channel-forming element can also be formed by a corrugated sheet or an expanded metal. On the hydrogen side, generally, no barrier-free channel routing is necessary, as the hydrogen finds its predetermined path in the stack in a pressure driven manner.

A gas diffusion layer, which is possibly supported by a support plate having one or more recesses, can also be used as a channel-forming element on the hydrogen side. This support plate can be formed in one piece with the frame, into which the material of the frame, which consists of sheet metal, is pressed in the region of the central recess, so that the required space for the gas diffusion layer is formed.

In order to ensure a virtually homogeneous supply of water over the entire surface of the proton exchange membrane (PEM) on the oxygen side, it is advantageous to provide a microporous layer which covers the sintered component on one side, specifically to the extent that the microporous layer reaches as far as the second frame. To stretch the microporous layer as far as this region is particularly advantageous, as any gaps between a channel-forming element or a gas diffusion layer inside the frame are thereby covered and therefore a completely even supply of the reactants takes place over the surface of the membrane.

A microporous layer of this type is advantageously produced as an individual component, e.g. as a film or as a green part or brown part of a film, placed onto the remaining components, particularly the second frame and the component which is integrated into the recess, and connected to the remaining components by sintering to form the sintered component. The microporous layer can alternatively also be applied onto the component by screen printing or stencil printing and is then subsequently sintered to the same.

The bipolar plate bears by way of its second frame and the porous transport layer, which is integrated therein, and the microporous layer, which is applied thereto, against the oxygen side of the proton exchange membrane.

Each electrolysis cell consists of a bipolar plate, a sealing frame and a proton exchange membrane (PEM), which is catalytically coated. The cells are stacked on top of one another, so that a bipolar plate is part of two adjacent electrolysis cells. This stack of electrolysis cells is clamped between two end plates, which are mechanically fastened to one another.

Advantageously, the thickness of the first metallic frame, which comprises the previously described channel-forming element in its central recess, is smaller than 1 mm, preferably smaller than 0.8 mm or particularly advantageously even smaller than 0.6 mm. This reduces the overall height of the stack and the material costs for production.

As, particularly in the case of very thin layer thicknesses, the inherent stability of the porous transport layer is not always ensured prior to the sintering, which is expedient when handling the components however, the porous transport layer may according to a development of the invention be produced with the aid of a feedstock which is fiber-reinforced, preferably with synthetic fibers, particularly preferably with polyethylene fibers. These fibers are removed in the process from green part to brown part and at the latest during sintering.

The channels provided in the channel-forming element of the sintered component can either reach as far as the corresponding channels which penetrate the cell stack or else, which is advantageous with regards to the pressure bearing capacity, be connected in the region between the central recess and the channels which penetrate the cell stack by channels which are formed by corresponding channel-shaped recesses in the first frame. Such recesses can be produced inexpensively by simple stamping and in the process, a certain overlapping is to be arranged, so that line connection to the channels, which penetrate the cell stack, takes place.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a very simplified perspective illustration of a water electrolysis stack according to the invention;

FIG. 2 is a very simplified exploded view of the structure of an individual electrolysis cell of the stack according to FIG. 1;

FIG. 3 is an exploded view of a first embodiment of the structure of a bipolar plate, which is formed by a sintered component;

FIG. 4 is a perspective partial sectional view through the components according to FIG. 2 in assembled form;

FIG. 5 is a partial sectional view corresponding to the components according to FIG. 4;

FIG. 6 is a view according to FIG. 5 of an alternative design;

FIG. 6.1 is a sectional view according to FIG. 6 with obliquely running section lines;

FIG. 7 is a view according to FIG. 5 of a further design variant; and

FIG. 8 is a view according to FIG. 5 of an alternative design variant.

### DESCRIPTION OF PREFERRED EMBODIMENTS

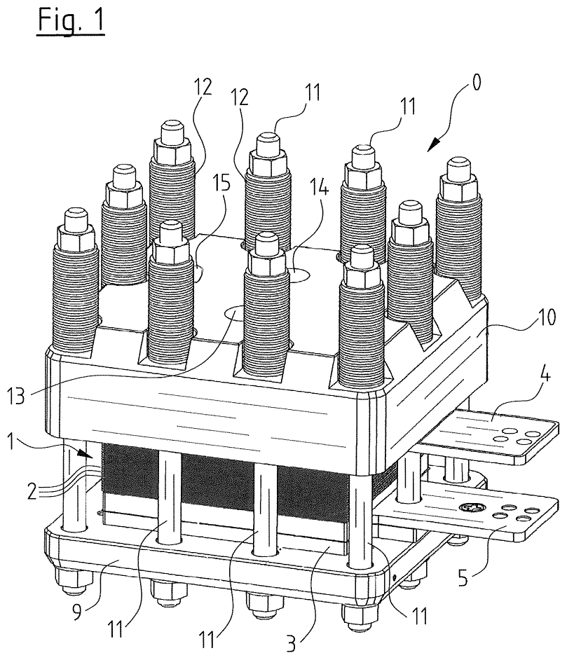

The fundamental structure of an electrolysis stack belongs to the prior art and is described in detail in WO 2019/228616, to which reference is made. The electrolysis stack 0, as illustrated with the aid of FIG. 1 therefore consists of a number of electrolysis cells 2, which are arranged above one another to form a stack 1 and which are clamped between two end plates 3 and are electrically connected in series. The electrical connections 4 and 5 are lead out of the stack 0 at the side. The supply of the cells 2 takes place via channels 6, 7, 8, which penetrate the cell stack 1, namely a first channel 6 for supplying the reactant water, and also as cooling water, and a second channel 7 for removing the cooling water and the product gas oxygen. These first and second channels 6, 7 are arranged oppositely and parallel to the long sides of the cell stack 1. Furthermore, at a transverse side of the cell stack 1, three third channels 8 are provided, which penetrate the stack 1 and are used for removing the product gas hydrogen. In the illustrated embodiment of the stack 0, the cell stack 1 is clamped, with the integration of insulating plates 3, between a lower end plate 9 and an upper end plate 10, which fastens by means of ten bolts 11 with the integration of disc spring stacks 12 in each case. In this case, the channels 6, 7, 8 are led out to channel connections in the upper end plate 10, in the figure the channel connections 13 and 14 are provided for connecting the first and second channels 6 and 7, whereas the channel connection 15 is connected to the third channel 8 and is used for removing the product gas hydrogen.

An electrolytic cell 2 has a catalytically coated proton exchange membrane 16 (PEM)—also termed a Membrane Electrode Assembly (MEA)—against the hydrogen side of which a sealing frame 17 bears, which seals the active part of the cell 2, that is to say the membrane 16 with respect to the channels 6, 7, 8 arranged to the side thereof and the channels 6, 7, 8 themselves to the outside. This sealing frame 17, which bears against the PEM 16 on the hydrogen side, that is to say on the side on which the product gas hydrogen is liberated, is likewise provided with seals 18 on the side facing away from the PEM 16 and bears there against a bipolar plate 19, which is configured as a sintered component made from titanium and the structure of which is also described in the following. The other side of a next bipolar plate 19 bears against the other side of the PEM 16, that is to say on the side on which oxygen is liberated as product gas and on which water is introduced as a reactant and water also flows past for cooling, which is normal in stacks of this type. Current is supplied via the electrical connections 4, 5, between the end plates 4, 9, 10.

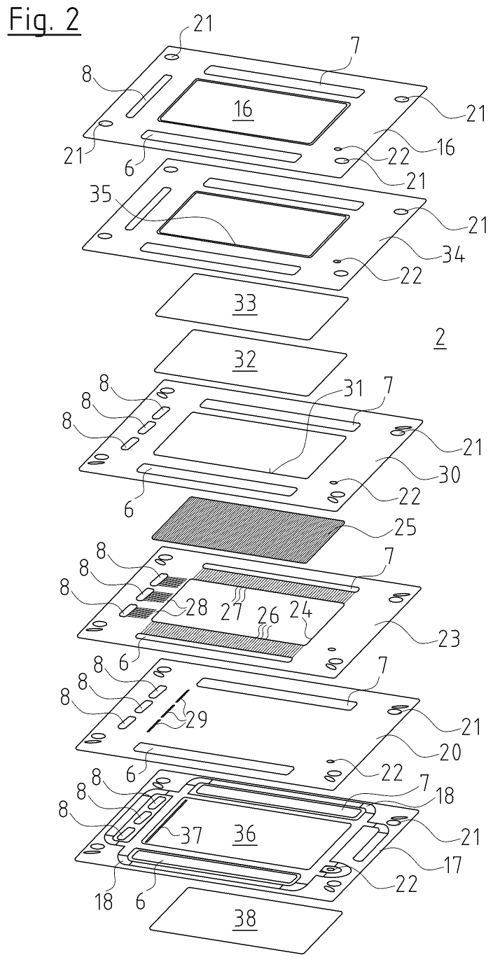

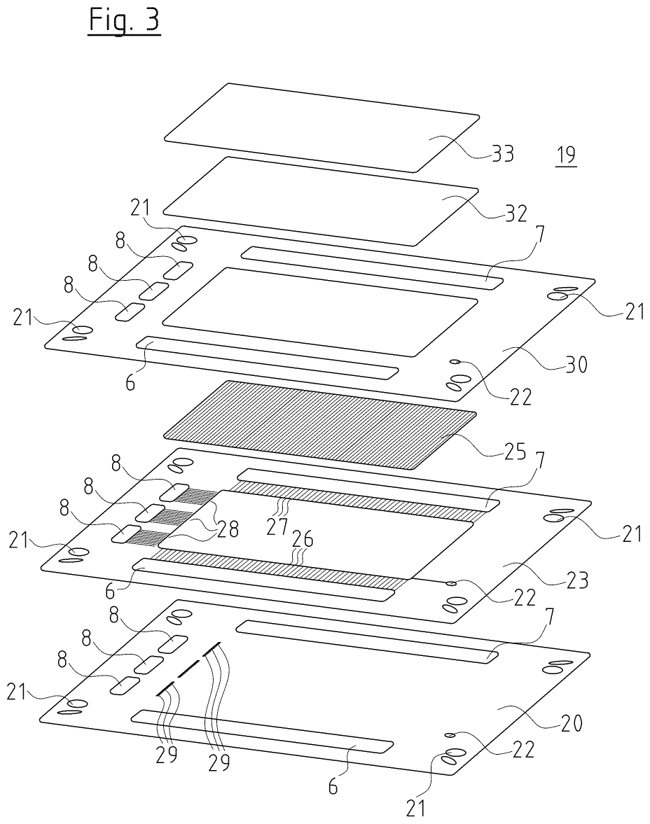

In the structure of the bipolar plate 19, which is illustrated with the aid of FIGS. 2 and 3, the bipolar plate has a flat metallic plate 20 made from titanium, which has a rectangular shape and is supplied in the corners with recesses 21 for guide bars for assembling the stack 0 and also on the long sides with recesses which form the first and the second channel 6 and 7 in the cell stack 1 and also on the short side with three recesses which form the third channel 8 in the cell stack 1, which is formed from three partial channels here. Parallel to the recesses for the third channel 8 a recess 22 is provided on the opposite side, which is provided for supplying nitrogen, using which the stack 0 is flushed before it is taken out of operation.

The bipolar plate 19 is configured as a sintered component and built from the components which are illustrated with the aid of FIG. 3 and consist of titanium in each case. One side of this bipolar plate 19 is formed by a flat metallic plate 20, the other side of which comes to bear against a first metallic frame component 23 which has a central recess 24 and also additionally the recesses which form the channels 6, 7, 8 flush with those in the first plate 20 and also the recesses for the guide bars and the recess for the nitrogen channel. The central recess 24 is provided for integrating a corrugated sheet 25 which is arranged such in the recess 24 of the first metallic frame component 23 that channels are formed, which then run between the first and the second channel 6, 7. However, the channels do not open out directly into the first and the second channel 6, 7, but rather into intermediate channels 26, 27 which are formed by impressions in the first metallic frame component 23 between the central recess 24 and the recesses for the first and the second channels 6, 7 which penetrate the stack.

Furthermore, this first frame component 23 has channel-forming impressions 28 in the transverse direction, which extend substantially from the narrow side of the central recess 24 as far as into the recesses which delimit the third channel 8. Via these recesses, the hydrogen channeled through recesses 29 in the flat plate 20 is conducted into the third channel 8 for removal of the hydrogen. The intermediate channels 26 and 27 and also the channels formed by the channel-forming impressions 28 can be formed either by impressions in the first metallic frame component 23 or by recesses, which are arranged in a comb-like manner and must be arranged such that they on the one hand form the required line connections and on the other hand remain materially connected, which can be achieved by corresponding overlaps into the channels 6, 7.

This first frame component 23 is adjoined by a second metallic frame component 30 which likewise has flush channel recesses and recesses for the guide bars and also furthermore a central recess 31 in which a porous transport layer 32 (Porous Transport Layer (PTL)), which is formed from titanium fibers, is integrated. This layer 32 is formed from a fiber-reinforced feedstock. This permeable transport layer 32 and the edge of the recess 31 is covered by a microporous transport layer 33 (Micro Porous Layer (MPL)), which is likewise formed from titanium. These components 20, 23, 25, 30, 32, 33, which form the later bipolar plate 19, are sintered lying on top of one another, so that a one-piece component 19 which consists of titanium is created, one side of which, namely on the oxygen side, bears against the PEM 16 and the other side of which bears via the sealing frame 17 against the subsequent PEM 16. To protect the PEM 16, the bipolar plate 19 does not bear against the PEM 16 directly, but rather is separated by a protective film 34, which likewise has a central recess 35 and corresponding channel-forming recesses and recesses for the guide bars and is therefore only effective outside of the active region of the electrolysis cell.

This sealing frame 17 has a support plate 36 where the active part of the cell is, that is to say flush with the central recess 24 provided in the metallic frame component 23, which support plate is formed by the material of the frame itself and can be formed in a closed or perforated manner, in order to remove the hydrogen from the membrane 16. This support plate 36 does not bear directly against the PEM 16, but rather with the interposition of a Gas Diffusion Layer 38 (GDL), which is formed from carbon fibers. Close to the recesses for the third channel 8, this support plate has a longitudinal slot 37, which lies flush with the recesses 29 in the flat plate 20 of the bipolar plate component and via which the hydrogen removal takes place.

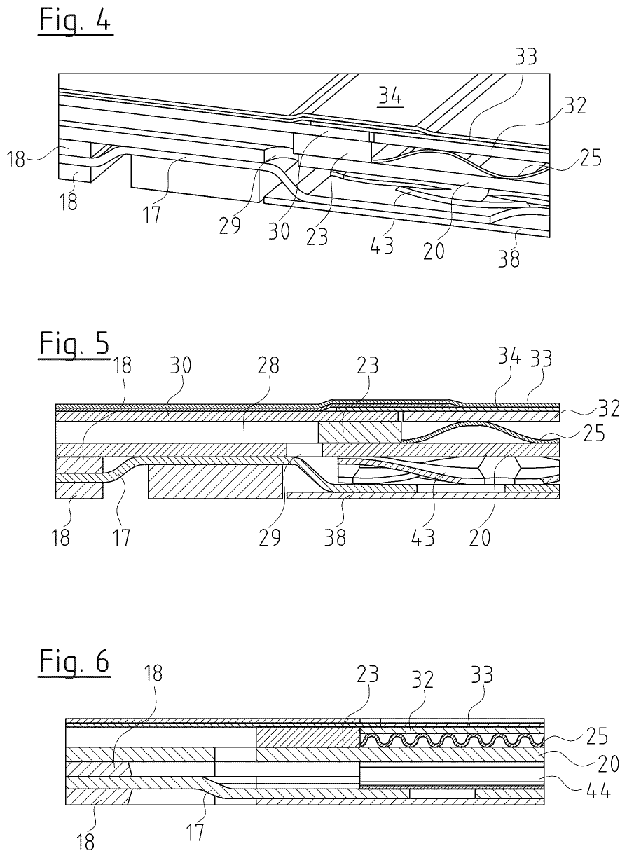

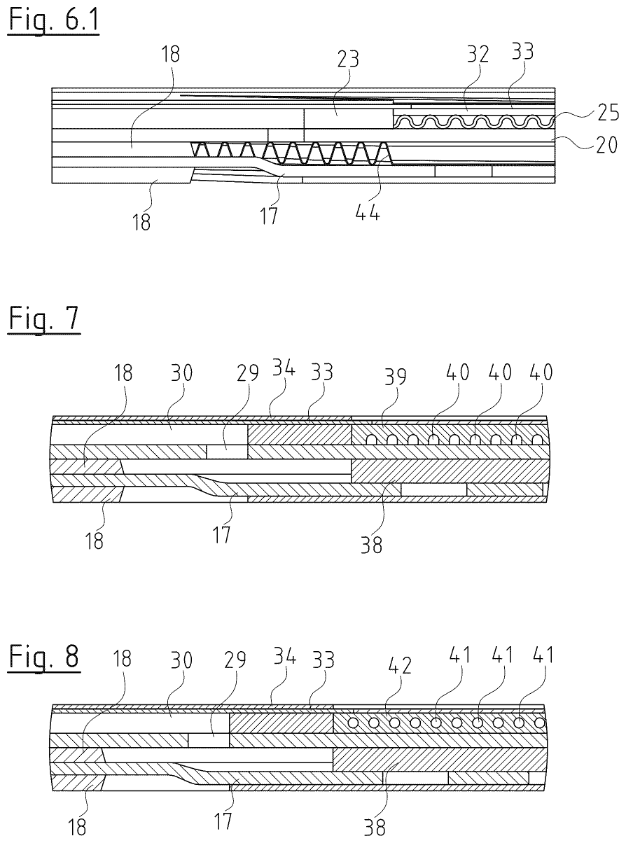

In the embodiment illustrated with the aid of FIGS. 4 and 5, the corrugated sheet 25 is formed to be somewhat sinusoidal in cross section and has a pronounced wave spacing compared to the wave height in cross section. This may also be configured completely differently however, as the sectional illustration according to FIG. 6 clarifies, there the wave spacing is only insignificantly larger than the wave height. This sinus shape may deviate towards a square wave and then produce cross sections which can be flowed through particularly well.

A corrugated sheet 44 (FIG. 6, FIG. 6.1) similar to the corrugated sheet 25 or an expanded metal 43 (FIG. 4, FIG. 5) can also be integrated in the sealing frame 17, which in addition to the channel formation should in particular also have a spring action, in order to evenly distribute the forces within the active part of the electrolysis cell 2.

On the hydrogen side, the corrosion requirements are lower than on the oxygen side, which is why the metal sealing sheet 17 and possibly also the expanded metal 43 or corrugated sheet 44 located on this side may not necessarily be manufactured from titanium, but rather alternatively also from high-grade steel with a corrosion protection coat.

As regards the channel-forming element in the sintered component 19, which forms the bipolar plate, instead of a corrugated sheet, this may also be formed by the stamping of corresponding channels into a porous transport layer 39, which replaces the PTL 32 in the second frame component 30 and the corrugated sheet 25 in the first frame component 23. This PTL 39 has channels 40 which are open towards the flat metallic plate 20, which extend from one to the other end of the PTL 39 and are arranged parallel next to one another. These channels in the sintered component 19, which are only still open at the end after the sintering are then closed at this one side by the flat metallic plate 20 or the sintered material formed thereby.

FIG. 8 shows a design variant in which channels 41 penetrate the PTL 42 in a similar manner, as is the case for the PTL 39 in FIG. 7, in which the channels 41 lie fully inside the PTL 42 and are only open at the end, however.

In the design variant illustrated with the aid of FIGS. 7 and 8, the central recess 24 in the first frame component 23 is provided continuously between the recesses for the first and second channels 6, 7, which penetrate the stack. Here, no corrugated sheet 25 is provided as a channel-forming element, which is integrated into the recess 24 and is used for channel transport between the first and second channels 6, 7, rather a channel-forming element in the form of a porous transport layer 39 or 42, which is penetrated by channels 40, 41, is provided. The channels are open on one side, namely towards the flat plate 20 and are closed by the same. As a result, comparatively large channel cross sections can be formed, furthermore, these channels 40, 41 are always permeable towards the transport channel, as they are integrated in the porous 5 transport layer 39, 42, that is to say although the channels 40, 41 have a certain guiding property, they do not have a fluid-tight channel wall, as is it the case for the channel-forming corrugated sheet 25 of the first design variant.

While specific embodiments of the invention have been shown and described in detail to illustrate the application of the principles of the invention, it will be understood that the invention may be embodied otherwise without departing from such principles.

### LIST OF REFERENCE NUMBERS

0 Electrolysis stack
1 Cell stack
2 Electrolysis cells
3 Insulating plates
4 Electrical connection
Electrical connection
6 First channel for supplying water
7 Second channel for removing water and oxygen
8 Third channel for removing hydrogen
9 Lower end plate
Upper end plate
11 Bolt
12 Disc spring stacks
13 Channel connection for supplying water
14 Channel connection for removing water and removing oxygen
Channel connection for removing hydrogen
16 Proton exchange membrane, PEM, also termed a Membrane Electrode Assembly (MEA)
17 Sealing frame
18 Sprayed on seals
19 Bipolar plate, sintered component
Flat metallic plate
21 Recesses for alignment pins
22 Recess for nitrogen flushing

1. A water electrolysis stack for producing hydrogen and oxygen from water, the water electrolysis stack comprising:
a number of electrolysis cells of PEM design, which are arranged to form a cell stack;
at least one first channel, which penetrates the cell stack, for supplying water;
at least one second channel, which penetrates the cell stack, for removing oxygen and water; and
at least one third channel, which penetrates the cell stack, for removing hydrogen, wherein the electrolysis cells comprise:
bipolar plates which are formed from at least one sintered component, which is constructed with a flat metallic plate, with a first metallic frame, which is arranged on the flat metallic plate;
a channel-forming element, which is integrated in the first metallic frame; and
a second metallic frame, which is arranged on the first metallic frame, having a porous transport layer, which is integrated therein, the channels of the channel-forming element line-connecting the first to the second channel of the channels which penetrate the cell stack.

2. The water electrolysis stack according to claim 1, wherein that the channel-forming element is formed by a corrugated sheet.

3. The water electrolysis stack according to claim 2, wherein the wave spacing of the corrugated sheet is smaller than 2 mm.

4. The water electrolysis stack according to claim 1, wherein the channel-forming element is a continuous porous transport layer, which is penetrated by channels.

5. The water electrolysis stack according to claim 1, wherein the channels of the channel-forming element are configured to be open on one side and are closed by the flat metallic plate.

6. The water electrolysis stack according to claim 4, wherein the channels of the channel-forming element are configured as closed channels inside the porous transport layer.

7. The water electrolysis stack according to claim 1, wherein the channels of the channel-forming element run straight and/or with the shape of a wavy line.

8. The water electrolysis stack according to claim 1, wherein the channels of the channel-forming element are constructed to be barrier-free.

9. The water electrolysis stack according to claim 1, wherein the flat metallic plate has recesses, which open out into channels which are formed in the first metallic frame and which open out into the third channel, which penetrates the cell stack, for removing hydrogen.

10. The water electrolysis stack according to claim 1, wherein a frame bears against the side of the bipolar plate formed by the flat metallic plate, which frame has a central recess, in which a further channel-forming element is arranged, the channels of which are line-connected to the recesses in the flat metallic plate.

11. The water electrolysis stack according to claim 10, wherein the further channel-forming element is formed by a gas diffusion layer.

12. The water electrolysis stack according to claim 10, wherein the further channel-forming element is formed by a corrugated sheet or expanded metal.

13. The water electrolysis stack according to claim 1, wherein the further channel-forming element preferably bears against the hydrogen side of a catalytically coated proton exchange membrane with the interposition of a support plate, which has recesses, and a gas diffusion layer.

14. The water electrolysis stack according to claim 1, wherein the sintered component is covered on one side by a microporous layer, which reaches as far as the second frame.

15. The water electrolysis stack according to claim 4, wherein the microporous layer is produced as an individual component, placed and connected to the remaining components by sintering to form the sintered component.

16. The water electrolysis stack according to claim 4, wherein the microporous layer is applied by screen printing or stencil printing and subsequently sintered.

17. The water electrolysis stack according to claim 4, wherein the bipolar plate bears by way of the second frame and the porous transport layer, which is integrated therein, and the microporous layer, which is applied thereto, against the oxygen side of a proton exchange membrane.

18. The water electrolysis stack according to claim 1, wherein the thickness of the first metallic frame is smaller than 1 mm.

19. The water electrolysis stack according to claim 1, wherein the porous transport layer is produced with the aid of a feedstock which is fiber-reinforced.

20. The water electrolysis stack according to claim 1, wherein channels are formed in the first metallic frame by recesses/impressions, which form a line connection to a channel which penetrates the cell stack.
